(19) United States
(12) Patent Application Publication
(10) Pub. No.: US 2009/0175201 A1
(43) Pub. Date: Jul. 9, 2009

(54) METHOD AND APPARATUS FOR CONFIGURING LINK PARAMETER THRESHOLDS

(75) Inventor: Junxiang Guo, Shenzhen (CN)

Correspondence Address: DARBY & DARBY P.C., P.O. BOX 770, Church Street Station, New York, NY, 10008-0770, US

(73) Assignee: Huawei Technologies Co., Ltd., Shenzhen (CN)

(21) Appl. No.: 12/402,956

(22) Filed: Mar. 12, 2009

Related U.S. Application Data
(63) Continuation of application No. PCT/CN2007/070682, filed on Sep. 12, 2007.

(30) Foreign Application Priority Data
Sep. 12, 2006 (CN) 200610127525.7

(51) Int. Cl. H04L 12/28

(52) U.S. Cl. 370/254

(57) ABSTRACT

A method and apparatus for configuring link parameter thresholds are provided. The method includes the following steps. An upper layer sends link parameter thresholds corresponding to different traffic types of a link type to an intermediate layer through a first threshold configuration request (401). The intermediate layer obtains the link parameter thresholds corresponding to different traffic types from the first threshold configuration request, and sends the obtained link parameter thresholds corresponding to different traffic types to a link layer through a second threshold configuration request (402). The method and apparatus configure the link parameter thresholds based on the traffic types, so as to meet requirements for communication quality of different traffics.

This application is a continuation of International Application No. PCT/CN2007/070682, filed on Sep. 12, 2007, which claims priority to Chinese Patent Application No. 200610127525.7, filed on Sep. 12, 2006, both of which are hereby incorporated by reference in their entireties.

### BACKGROUND

1. Field

The disclosure relates to a mobile communication technology, and more particularly to a method and an apparatus for configuring link parameter thresholds.

2. Background

In the current mobile communication system, both mobile terminals and network equipments (such as base stations and access points) can be multi-modal, i.e., capable of supporting multiple radio standards and simultaneously supporting transmits voice, data, and other services on more than one radio interface. Further, the mobile communication system can include a mixture of cells of different sizes, such as those from IEEE 802.15, IEEE 802.11, IEEE 802.16, 3GPP, and 3GPP2, with overlapping coverage. At this time, the mobile terminals perform handover between different types of radio access networks.

To better solve the problem of handover between radio networks including the IEEE802.3, IEEE802.11, IEEE802.16, 3GPP, and 3GPP2, IEEE802.21 workgroup is established. The IEEE802.21 workgroup is responsible for creating a public handover framework, that is, a media independent handover (MIH) standard 802.21, for guiding the handover among the IEEE802.3/11/16 and 3G standards.

The main content of the MIH standard 802.21 is: implementing a set of handover function sets between network elements (NEs), and configuring the handover function sets in mobility management protocol stacks of the NEs to form a new protocol layer, that is, an MIH layer. The MIH layer supports following services: 1) MIH Event Service (MIH-ES), which is adapted to provide event classification, event filter, and event report for dynamic events related to link features, link status, and link quality; 2) MIH Command Service (MIH-CS), which is adapted to provide MIH user management and control link activities related to handover and mobility; and 3) MIH Information Service (MIH-IS), which is adapted to provide features and traffic information of serving networks and peripheral networks, and perform effective system access and handover decision.

FIG. 1 shows a general reference model of an MIH system including an MIH user layer, an MIH layer, and a link layer. The FIG. 1 also shows service access points (SAPs) between the MIH layer and the MIH user layer and SAPs between the MIH layer and the link layer. The MIH user layer is an upper layer, which is a mobility management and application protocol layer. The MIH user layer is configured with mobility management protocols such as Mobile IP v4/v6 (MIPv4/v6), Session Initiation Protocol (SIP), and 3GPP UL, and policies with regard to handover, transmission, and application. The MIH layer is an intermediate layer, adapted to provide the MIH-ES, MIH-CS, and MIH-IS. The link layer is a lower layer, adapted to manage links of radio access networks, and report relevant events to the upper layer in time when actual link parameters such as a bit error rate (BER) of a link exceed the link parameter thresholds, so that the upper layer makes handover decision according to the events. The link parameter thresholds are important parameters for executing the media independent handover, which influence the communication quality of the entire system to a great extent.

In the prior art, as shown in FIG. 2, the configuration process of the link parameter thresholds is as follows.

The MIH user layer 21 sends an MIH_Configure_Thresholds.request to the MIH layer 22, and requests to configure link parameter thresholds for a certain link type. The link parameter thresholds are adapted to measure the quality of the link type, and generally may include one of or a plurality of the following parameters: a quality of service (QoS) threshold, a delay threshold, a BER threshold, and a link rate threshold.

After receiving the MIH_Configure_Thresholds.request, the MIH layer 22 sends a Link_Configure_Thresholds.request to the link layer 23, and requests the link layer 23 to configure the link parameter threshold for the specified link.

The format of the Link_Configure_Thresholds.request command is Link_Configure_Thresholds.request(LinkParameterList). The LinkParameterList includes the following parameters: 1) LinkParameterType, which is a 2-tuple of the link type and the link parameter type, for example {UMTS:BER}; 2) InitiateActionThreshold; 3) RollbackActionThreshold; and 4) ExecuteActionThreshold.

After configuring the thresholds, the link layer 23 sends a Link_Configure_Thresholds.confirm to respond to the Link_Configure_Thresholds.request.

The format of the Link_Configure_Thresholds.confirm command is Link_Configure_Thresholds.confirm(LinkParameterStatusList). The LinkParameterStatusList includes the following parameters: 1) LinkParameterType, which is a 2-tuple of the link type and the parameter type, for example {UMTS:BER}; and 2) Status, which is of an enumerated type, and has two values of success and error.

After receiving the Link_Configure_Thresholds.confirm, the MIH layer 22 sends an MIH_Configure_Thresholds.confirm to the MIH user layer 21.

According to the current protocol, MIH_Configure_Thresholds.request and Link_Configure_Thresholds.request have the same format; and MIH_Configure_Thresholds.confirm and Link_Configure_Thresholds.confirm have the same format.

According to the process shown in FIG. 2, the MIH user layer 21 may set the corresponding link parameter thresholds for a link type each time, in which the link parameter thresholds of the same link type are identical.

### SUMMARY

The present disclosure is directed to a method and apparatus for configuring link parameter thresholds. Technical solutions of the present disclosure are implemented as follows.

A method for configuring link parameter thresholds includes: an intermediate layer receives link parameter thresholds corresponding to different traffic types of a link type, through a first threshold configuration request from an upper layer; and send the received link parameter thresholds through a second threshold configuration request to a link layer.

An apparatus for configuring link parameter thresholds includes an upper layer entity adapted to send link parameter thresholds corresponding to different traffic types of a link type through a first threshold configuration request.

Another apparatus for configuring link parameter thresholds includes a link layer entity adapted to obtain link parameter thresholds of different traffic types, and configure link parameter thresholds of the corresponding traffic types according to the link parameter thresholds.

It is known from the above technical solutions that the method and apparatus for configuring link parameter thresholds configure the link parameter thresholds based on the traffic types. Thus, different link parameter thresholds may be configured for the traffic types corresponding to one link type, so as to meet requirements for communication quality of different traffics.

In the method for configuring link parameter thresholds according to another embodiment of the present invention, the upper layer may configure the corresponding link parameter thresholds for multiple link types, that is, more than one link type, in one time instead of in multiple times, so as to improve the configuration efficiency and make the configuration more flexible.

### BRIEF DESCRIPTION OF THE DRAWINGS

The embodiments will become more fully understood from the detailed description given herein below for illustration only, and thus are not limitative of the present invention, and wherein:

FIG. 1 shows a general reference model of media independent handover in the prior art;

FIG. 2 is a flow chart of a process for configuring link parameter thresholds in the prior art;

FIG. 3 is a flow chart of a process for configuring link parameter thresholds according to an embodiment of the present invention;

FIG. 4 is a flow chart of a process for configuring link parameter thresholds according to another embodiment of a present invention;

FIG. 5 is an illustration of a system for configuring link parameter thresholds according to another embodiment of the present invention; and

FIG. 6 is an illustration of an apparatus for configuring link parameter thresholds according to another embodiment of the present invention.

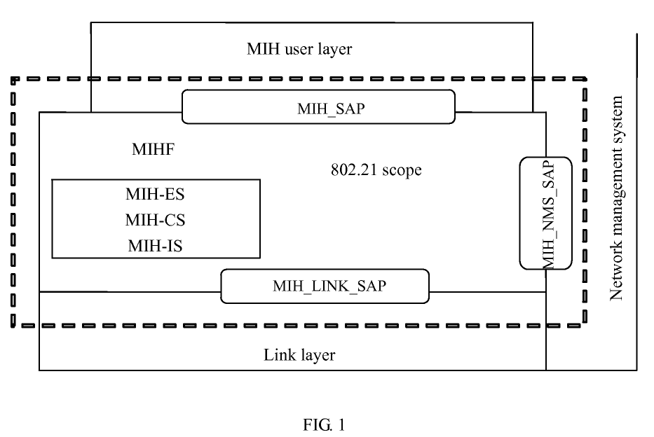

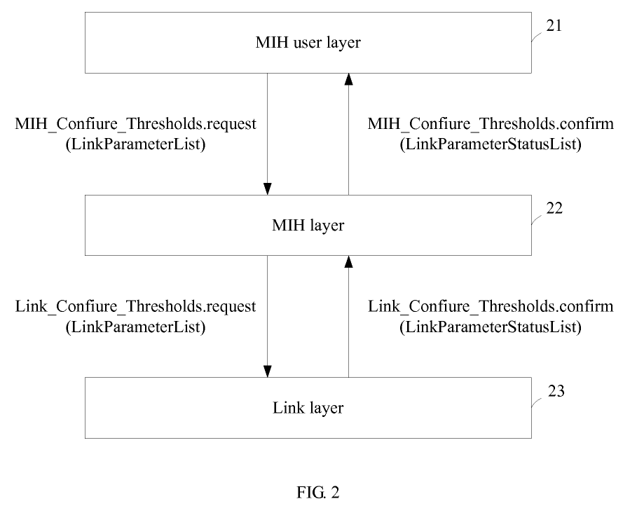

### DETAIL DESCRIPTION

Embodiments of the present invention are illustrated in detail below with the accompanying drawings.

Link parameter thresholds are important parameters of a mobile communication system, which influences the communication quality of the system to a great extent. In particular, the link parameter thresholds are very important in the process for triggering the network handover. The network handover may occur in the same network or occur between different networks, that is, the media independent handover (MIH).

In the process for configuring link parameter thresholds according to an embodiment of the present invention, an upper layer sends link parameter thresholds corresponding to different traffic types of a link type to an intermediate layer through a first threshold configuration request; and the intermediate layer obtains the link parameter thresholds corresponding to different traffic types from the first threshold configuration request, and sends the obtained link parameter thresholds corresponding to different traffic types to a link layer through a second threshold configuration request.

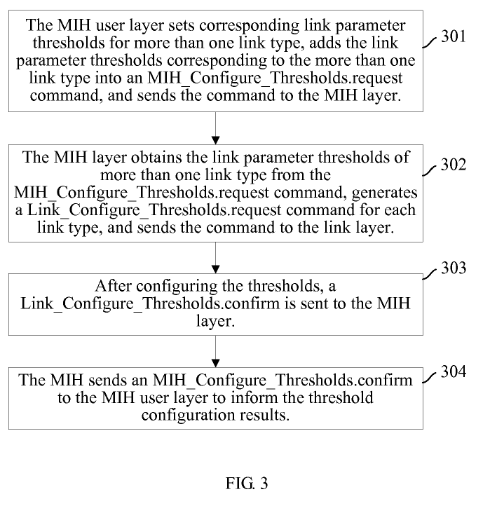

In particular, FIG. 3 shows a process for configuring the link parameter thresholds according to an embodiment of the present invention. In this embodiment, the upper layer is an MIH user layer, and the first threshold configuration request sent by the upper layer is an MIH_Configure_Thresholds.request message; and the intermediate layer is an MIH layer, and the second threshold configuration request sent by the intermediate layer is a Link_Configure_Thresholds.request message. The process is as follows.

In Step 301, the MIH user layer sets corresponding link parameter thresholds for at least one link type, adds the link parameter thresholds corresponding to the at least one link type into an MIH_Configure_Thresholds.request command, and sends the command to the MIH layer. The at least one link type may be one or more link types.

As links of the same type may bear traffics of different types, that is, one link type may bear multiple traffic types, the MIH user layer may set the corresponding link parameter thresholds for different traffic types of each link type, and record and send the link parameter thresholds of all traffic types of the link type in the MIH_Configure_Thresholds.request command. The traffic types bearable by a link type are referred to as the traffic types of the link type.

In specific implementations, the MIH layer serving as the upper layer may set the corresponding link parameter thresholds for different traffic types of one link type, record the link parameter thresholds corresponding to different traffic types in the first threshold configuration request, and send the first threshold configuration request to the MIH layer serving as the intermediate layer.

Alternatively, the MIH user layer serving as the upper layer may set the corresponding link parameter thresholds for different traffic types of more than one link type, and sends the link parameter thresholds to the MIH layer serving as the intermediate layer through a first threshold configuration request.

Here, the first threshold configuration request is the MIH_Configure_Thresholds.request message.

Further, the MIH user layer may obtain a Destination Identifier, and then add the Destination Identifier into the MIH_Configure_Thresholds.request command sent to the MIH layer. Thus, the receiver of this command can be identified correctly. Alternatively, the MIH user layer obtains a Source Identifier, and then adds the Source Identifier into the MIH_Configure_Thresholds.request command sent to the MIH layer. Thus, the sender of this command can be identified correctly. Alternatively, the MIH_Configure_Thresholds.request command carries both the Source Identifier and the Destination Identifier.

In a specific example, the format of the MIH_Configure_Thresholds.request command is MIH_Configure_Thresholds.request(SourceIdentifier, DestinationIdentifier, MultiLinkParameterList), and the command includes the parameters of Source Identifier, Destination Identifier, and MultiLinkParameterList.

1. The Source Identifier and the Destination Identifier are adapted to identify the sender and receiver of the MIH_Configure_Thresholds.request command respectively.

2. The MultiLinkParameterList includes the parameters of LinkType and LinkParameterList.

1) The LinkType is the identifier of the link to be configured.

2) The LinkParameterList includes the parameters of TrafficType and LinkParameterThresholdList.

(i) The TrafficType is related to the link type, and varies for different link types. For example, for the 3GPP, the TrafficType may be conversational, streaming, interactive, or background.

(ii) The LinkParameterThresholdList includes the parameters of LinkParameterType, InitiateActionThreshold, RollbackActionThreshold, and ExecuteActionThreshold.

In specific implementation, a LinkParameterList is set for each link type, which records the link parameter thresholds corresponding to different traffic types of the link type. Then, all link types and the corresponding LinkParameterList parameters are recorded as the MultiLinkParameterList.

Table 1 shows a detailed description of all of the above parameters. The MIH user layer may configure the corresponding link parameter thresholds for one or more link types, i.e., for at least one link type in the MultiLinkParameterList, and the corresponding TrafficType and LinkParameterThresholdList are stored for each link type.

It should be noted that when the link parameter thresholds are configured for one link type, the MIH_Configure_Thresholds.request command may not include the MultiLinkParameterList parameter line. For example, when the link parameter thresholds are configured for one link type, the MIH_Configure_Thresholds.request includes the parameters of Destination Identifier, LinkType, and LinkParameterList.

TABLE 1

| Name | Type | Valid Range | Description |
|---|---|---|---|
| SourceIdentifier | Identifier | Any valid individual or | The identifier of entity |
| | | group identifier | where the request is |
| | | | initiated. This field may |
| | | | be optionally left empty if |
| | | | the command is local. |
| DestinationIdentifier | Identifier | MIH_LOCAL, MIH_REMOTE | The destination identifier of |
| | | | request or response. This |
| | | | is the identifier of local or |
| | | | peer MIH Function. |
| MultiLinkParameterList | List | Not Available(N/A) | A list of following set of |
| | | | parameters: |
| | | | LinkType, |
| | | | LinkParameterList |
| >LinkType | Link Identifier(248) | N/A | Identifier of the link to |
| | | | configure. |
| >LinkParameterList | List | N/A | A list of following set of |
| | | | parameters: |
| | | | TrafficType, |
| | | | LinkParameterThresholdList |
| >>TrafficType | INTEGER | 0x00: all types | Traffic class for which |
| | | 0x01: conversational | thresholds may be set. |
| | | 0x02: streaming | |
| | | 0x03: interactive | |
| | | 0x04: background | |
| | | 0x05~0xff: reserved | |
| >>LinkParameterThresholdList | List | N/A | A list of following set of |
| | | | parameters: |
| | | | LinkParameterType, |
| | | | InitiateActionThreshold, |
| | | | RollbackActionThreshold, |
| | | | ExecuteActionThreshold |
| >>>LinkParameterType | Link Quality | N/A | Parameters for which |
| | Parameter Type(8) | | thresholds may be set. |
| | | | LinkParameterType is |
| | | | media specific. |
| >>>InitiateActionThreshold | Link parameter | N/A | Threshold value which may |
| | Threshold(16) | | cause Upper layers to start |
| | | | “setup” type activities in |
| | | | response to actual parameter |
| | | | values crossing this |
| | | | threshold. |
| >>>RollbackActionThreshold | Link parameter | N/A | Threshold value which may |
| | Threshold(16) | | cause Upper layers to cancel |
| | | | or rollback the above setup |
| | | | type operation if the actual |
| | | | parameter values retreat to |
| | | | this threshold. |
| >>>ExecuteActionThreshold | Link parameter | N/A | Threshold value which may |
| | Threshold(16) | | cause Upper layers to |
| | | | execute taking appropriate |
| | | | action if the actual |
| | | | parameter values cross this |
| | | | threshold. |

In Step 302, the MIH layer obtains the link parameter thresholds corresponding to at least one link type from the MIH_Configure_Thresholds.request command, generates a Link_Configure_Thresholds.request command for each link type, adds the link parameter thresholds of the link type into the corresponding Link_Configure_Thresholds.request command, and sends the command to the link layer.

In particular, when the MIH_Configure_Thresholds.request command carries the link parameter thresholds of more than one link type, after receiving the first threshold configuration request containing the link parameter thresholds corresponding to different traffic types of more than one link type, the MIH layer serving as the intermediate layer records the link parameter thresholds corresponding to different traffic types of each of the link types in a second threshold configuration request generated for the link type, and sends the request to the link layer.

The first threshold configuration request is the MIH_Configure_Thresholds.request message, and the second threshold configuration request is the Link_Configure_Thresholds.request message.

In a specific example, the format of the Link_Configure_Thresholds.request command is Link_Configure_Thresholds.request(LinkParameterList). Table 2 lists the detailed setting of this command.

TABLE 2

| Name | Type | Valid Range | Description |
|---|---|---|---|
| LinkParameterList | List | N/A | A list of following set of |
| | | | parameters: |
| | | | TrafficType |
| | | | LinkParameterThresholdList |
| >TrafficType | INTEGER | 0x00: all types | Traffic classes for which |
| | | 0x01: conversational | thresholds may be set. |
| | | 0x02: streaming | |
| | | 0x03: interactive | |
| | | 0x04: background | |
| | | 0x05~0xff: reserved | |
| >LinkParameterThresholdList | List | N/A | A list of following set of |
| | | | parameters: |
| | | | LinkParameterType, |
| | | | InitiateActionThreshold, |
| | | | RollbackActionThreshold, |
| | | | ExecuteActionThreshold |
| >>LinkParameterType | Link Quality | N/A | Parameters for which |
| | Parameter | | thresholds may be set. |
| | Type(8) | | LinkParameterType is media |
| | | | specific. |
| >>InitiateActionThreshold | Link | N/A | Threshold value which may |
| | parameter | | cause Upper layers to start |
| | Threshold(16) | | “setup” type activities in |
| | | | response to actual parameter |
| | | | values crossing this |
| | | | threshold. |
| >>RollbackActionThreshold | Link | N/A | Threshold value which may |
| | parameter | | cause Upper layers to cancel |
| | Threshold(16) | | or rollback the above setup |
| | | | type operation if the actual |
| | | | parameter values retreat to |
| | | | this threshold. |
| >>ExecuteActionThreshold | Link | N/A | Threshold value which may |
| | parameter | | cause Upper layers to |
| | Threshold(16) | | execute taking appropriate |
| | | | action if the actual |
| | | | parameter values cross this |
| | | | threshold. |

In Step 302, the content of the LinkParameterList is sent from the MIH_Configure_Thresholds.request command. As each Link_Configure_Thresholds.request command sent by the MIH layer is directed to a specific link type, the Link_Configure_Thresholds.request command does not need to carry the LinkType parameter, which saves the information bits of the Link_Configure_Thresholds.request.

Moreover, it is known from Table 1 that the DestinationIdentifier parameter in the MIH_Configure_Thresholds.request may have two values: MIH_LOCAL and MIH_REMOTE.

When the destination of the MIH_Configure_Thresholds.request is a local MIH layer entity, the local MIH layer entity sends the Link_Configure_Thresholds.request to the link layer serving as a lower layer.

When the destination of the MIH_Configure_Thresholds.request is a remote MIH layer entity, the local MIH layer entity sends the MIH_Configure_Link.request to the remote MIH layer entity, and the remote MIH layer entity then sends the Link_Configure_Thresholds.request to the link layer serving as the lower layer.

Thus, the link layer may configure the link parameter thresholds of a link type according to attribute parameters of the link type carried in the Link_Configure_Thresholds.request. The detailed configuration process is as follows. The link layer records the attribute parameters of the link type carried in the Link_Configure_Thresholds.request as the link parameter thresholds of the link type, and generates the threshold configuration status of the link type, such as success or failure. Certainly, the link layer may also obtain the link parameter thresholds corresponding to different traffic types of the link type from the Link_Configure_Thresholds.request, configure the link parameter thresholds of the corresponding traffic types according to the link parameter thresholds, and generate a threshold configuration status for each traffic type.

The process for configuring the link parameter thresholds may further include Step 303 and Step 304.

In Step 303, after configuring the thresholds, the link layer sends a Link_Configure_Thresholds.confirm to respond to the Link_Configure_Thresholds.request.

Table 3 lists the setting of the Link_Configure_Thresholds.confirm command, which includes a LinkParameterStatusList for recording the configuration status of link parameters. The LinkParameterStatusList includes the parameters of TrafficType and Status, and is adapted to record the threshold configuration result corresponding to each traffic type one by one. Certainly, the link layer may provide a threshold configuration status for a link type, or provide a corresponding threshold configuration status for each traffic type of the link type.

TABLE 3

| Name | Type | Valid Range | Description |
|---|---|---|---|
| LinkParameterStatus- | List | N/A | A list of |
| List | | | following |
| | | | set of |
| | | | parameters: |
| | | | TrafficType |
| | | | Status |
| >TrafficType | INTEGER | 0x00: all types | Traffic class |
| | | 0x01: conversational | for which |
| | | 0x02: streaming | thresholds |
| | | 0x03: interactive | may be set. |
| | | 0x04: background | |
| | | 0x05~0xff: reserved | |
| >Status | Enumerated | Success | Status of |
| | | Error | operation |

In Step 304, after receiving the Link_Configure_Thresholds.confirm, the MIH sends an MIH_Configure_Thresholds.confirm to the MIH user layer to inform the threshold configuration results.

In a specific example, the format of the MIH_Configure_Thresholds.confirm command is MIH_Configure_Thresholds. confirm(SourceIdentifier,DestinationIdentifier,MultiLinkParameterStatusList). Table 4 lists the detailed setting of this command, which includes the parameters of SourceIdentifier, DestinationIdentifier, and MultiLinkParameterStatusList. Preferably, the MIH_Configure_Thresholds.confirm command carries only the SourceIdentifier, but does not carry the DestinationIdentifier.

The MultiLinkParameterStatusList includes the parameters of LinkType and LinkParameterStatusList.

Furthermore, the LinkParameterStatusList includes the parameters of TrafficType and Status, in which the Status parameter is adapted to identify the threshold configuration result, and has two values of success and error.

TABLE 4

| Name | Type | Valid Range | Description |
|---|---|---|---|
| SourceIdentifier | Identifier | Any valid individual | The identifier of entity |
| | | or group identifier | where the request is |
| | | | initiated. This field may |
| | | | be optionally left empty if |
| | | | the command is local. |
| DestinationIdentifier | Identifier | MIH_LOCAL, | The destination identifier |
| | | MIH_REMOTE | of request or response. |
| | | | This is the identifier of |
| | | | local or peer MIH |
| | | | Function. |
| MultiLinkParameterStatus- | List | N/A | A list of following set of |
| List | | | parameters: |
| | | | LinkType, |
| | | | LinkParameterStatusList |
| >LinkType | Link | N/A | Identifier of the link to |
| | Identifier | | configure. |
| | (248) | | |
| >LinkParameterStatusList | | N/A | A list of following set of |
| | | | parameters: |
| | | | TrafficType, |
| | | | Status |
| >>TrafficType | INTEGER | 0x00: all types | Traffic class for which |
| | | 0x01: conversational | thresholds may be set. |
| | | 0x02: streaming | |
| | | 0x03: interactive | |
| | | 0x04: background | |
| | | 0x05~0xff: reserved | |
| >>Status | Enumerated | Success | Status of operation |
| | | Error | |

When managing a link set up by the link layer, the link layer finds the corresponding link parameter thresholds according to the link type of the link or according the traffic types of the link type, compares the link parameter thresholds with actual link parameters, and initiates a link parameter change report when the actual link parameters exceed the link parameter thresholds. The MIH user layer may determine whether to perform the MIH according to a handover policy and the parameter change report.

It should be noted that the link parameter thresholds may be configured on a mobile node (MN), or on a network equipment such as a Serving Point of Service (Serving PoS) or a Candidate Point of Service (Candidate PoS).

According to the solution provided in the above embodiment, the link parameter thresholds of multiple link types are configured in one time, so that the efficiency for configuring the link parameter thresholds is improved, and the configuration becomes more flexible.

A system for configuring link parameter thresholds is also provided. The system includes an MIH user layer entity, an MIH layer entity, and a link layer entity.

The MIH user layer entity is adapted to set corresponding link parameter thresholds for a plurality of link types. Further, the MIH user layer entity may send the set link parameter thresholds of different link types to the MIH layer entity through an MIH_Configure_Thresholds.request. Here, the plurality of link types may be more than one link type.

The MIH layer entity is adapted to read information carried in the MIH_Configure_Thresholds.request after receiving the request, and find that the request carries the link parameter thresholds corresponding to the plurality of link types through analysis. Then, the MIH layer entity generates a Link_Configure_Thresholds.request for each of the link types, records the link parameter thresholds of each link type in the corresponding Link_Configure_Thresholds.request, and sends the request to the link layer entity.

The link layer entity is adapted to configure the link parameter thresholds of the corresponding link type according to the information carried in each Link_Configure_Thresholds.request.

An MIH user layer apparatus is also provided in an embodiment of the present invention. The MIH user layer apparatus is adapted to set corresponding link parameter thresholds for one or more link types, and send the link parameter thresholds to other apparatuses such as an MIH layer apparatus through an MIH_Configure_Thresholds.request.

An MIH layer apparatus is also provided in an embodiment of the present invention. The MIH layer apparatus is adapted to read link parameter thresholds corresponding to at least one link type carried by an MIH_Configure_Thresholds.request, generate a Link_Configure_Thresholds.request for each of the link types, record the link parameter thresholds of each link type in the corresponding Link_Configure_Thresholds.request, and send the request to other apparatuses such as a link layer apparatus.

In actual applications, the link of the same type may bear different types of traffics, and different traffic types have different requirements for the communication quality. That is, for different traffic types, even if the link type is the same, the required link parameter thresholds may also be different. For example, if the link type is 3GPP, which has four traffic types, namely, conversational, streaming, interactive, and background, the BER threshold of the conversational traffic may be set as 5×10⁻², and the BER threshold of the interactive traffic may be set as 4×10⁻³.

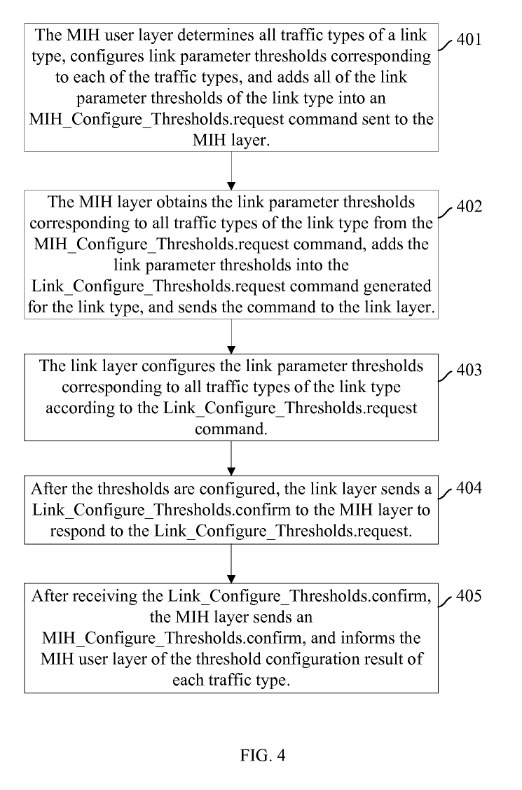

In another embodiment of the present invention, the requirements for the communication quality of different traffic types are fully considered in the configuration of the link parameter thresholds, that is, different link parameter thresholds may be configured for different traffic types, as shown in FIG. 4.

In Step 401, the MIH user layer determines all traffic types of a link type, configures link parameter thresholds corresponding to each of the traffic types, and adds all of the link parameter thresholds of the link type into an MIH_Configure_Thresholds.request command sent to the MIH layer.

In a specific example, the format of the MIH_Configure_Thresholds.request command is MIH_Configure_Thresholds.request(SourceIdentifier,DestinationIdentifier,LinkType,LinkParameterList), and the command includes the parameters of Source Identifier, Destination Identifier, LinkType, and LinkParameterList. Similar to the embodiment shown in FIG. 3, the MIH_Configure_Thresholds.request may also carry only the Destination Identifier, but does not need to carry the Source Identifier.

The LinkParameterList includes the parameters of TrafficType and LinkParameterThresholdList. The TrafficType is related to the link type, and varies for different link types. For example, for the 3GPP, the TrafficType may be conversational, streaming, interactive, or background. The LinkParameterThresholdList includes the parameters of LinkParameterType, InitiateActionThreshold, RollbackActionThreshold, and ExecuteActionThreshold.

In Step 402, the MIH layer obtains the link parameter thresholds corresponding to all traffic types of the link type from the MIH_Configure_Thresholds.request command, adds the link parameter thresholds into the Link_Configure_Thresholds.request command generated for the link type, and sends the command to the link layer.

The parameter setting of the Link_Configure_Thresholds.request is similar to Step 302, and will not be described herein again.

In Step 403, the link layer configures the link parameter thresholds corresponding to all traffic types of the link type according to the Link_Configure_Thresholds.request command.

In Step 404, after the thresholds are configured, the link layer sends a Link_Configure_Thresholds.confirm to the MIH layer to respond to the Link_Configure_Thresholds.request.

The parameter setting of the Link_Configure_Thresholds.confirm is similar to Step 303, and will not be described herein again.

In Step 405, after receiving the Link_Configure_Thresholds.confirm, the MIH layer sends an MIH_Configure_Thresholds.confirm, and informs the MIH user layer of the threshold configuration result of each traffic type.

Certainly, the MIH layer may inform the MIH user layer of the threshold configuration status of the link type, or of the threshold configuration status of each traffic type of the link type.

In a specific example, the format of the MIH_Configure_Thresholds.confirm command is MIH_Configure_Thresholds.confirm(SourceIdentifier,DestinationIdentifier,LinkType,LinkParameterStatusList), and the command includes the parameters of SourceIdentifier, DestinationIdentifier, LinkType, and LinkParameterStatusList.

The LinkParameterStatusList includes the parameters of TrafficType and Status.

In the above process, as the link parameter thresholds are configured based on the traffic types, the method makes the configuration more flexible, satisfies the requirements for the communication quality of different traffics, improves the accuracy of the MIH control, and enables the system to make the handover decision more suitable for the actual network condition.

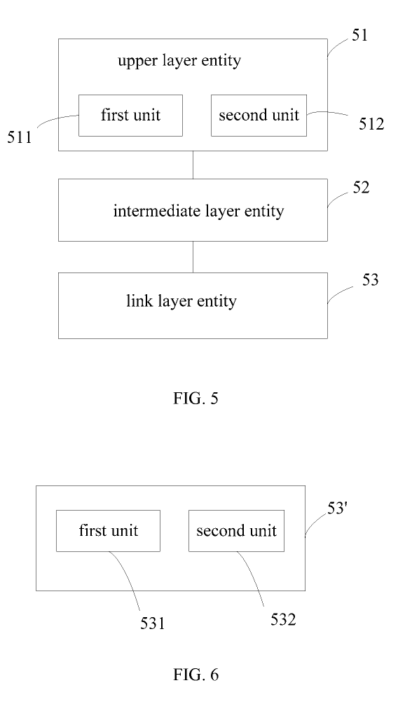

As FIG. 5 shows, a system for configuring link parameter thresholds is also provided in an embodiment of the present invention. The system includes an upper layer entity 51, an intermediate layer entity 52, and a link layer entity 53.

The upper layer entity 51 is adapted to send link parameter thresholds corresponding to different traffic types of a link type to the intermediate layer through a first threshold configuration request.

The intermediate layer entity 52 is adapted to obtain the link parameter thresholds corresponding to different traffic types from the first threshold configuration request, and send the obtained link parameter thresholds corresponding to different traffic types to the link layer 53 through a second threshold configuration request.

The upper layer entity 51 includes a first unit 511 and a second unit 512. The first unit 511 is adapted to set the link parameter thresholds corresponding to different traffic types of a link type, and the second unit 512 is adapted to record the link parameter thresholds corresponding to different traffic types in the first threshold configuration request, and send the first threshold configuration request to the intermediate layer entity 52.

The intermediate layer entity 52 is further adapted to record the link parameter thresholds of different traffic types in the second threshold configuration request generated for the link type after receiving the first threshold configuration request containing the link parameter thresholds of different traffic types, and send the second threshold configuration request to the link layer entity 53.

The link layer entity 53 is adapted to obtain the link parameter thresholds of different traffic thresholds from the second threshold configuration request, and configure link parameter thresholds of the corresponding traffic types according to the link parameter thresholds.

The link layer entity 53 is further adapted to generate a threshold configuration status for the link type, and send a first threshold configuration confirmation carrying the threshold configuration status to the intermediate layer entity 52.

The intermediate layer entity 52 is further adapted to obtain the threshold configuration status from the first threshold configuration confirmation sent from the link layer, add the threshold configuration status into a second threshold configuration confirmation of the link type, and send the second threshold configuration confirmation to the upper layer entity 51.

The link layer entity 53 is further adapted to generate a threshold configuration status for each of the traffic types of the link type, and send a first threshold configuration confirmation carrying the threshold configuration status to the intermediate layer entity 52.

The intermediate layer entity 52 is further adapted to obtain the threshold configuration status from the first threshold configuration confirmation sent from the link layer, add the threshold configuration status into a second threshold configuration confirmation of the link type, and send the second threshold configuration confirmation to the upper layer entity 51.

In actual applications, the user layer entity 51, the intermediate layer entity 52, and the link layer entity 53 may be disposed in the same NE or in different NEs. At this time, if the three entities are disposed in the same NE, the system refers to an NE for configuring link parameter thresholds.

A user layer apparatus is also provided in an embodiment of the present invention. The user layer apparatus includes at least one unit adapted to configure link parameter thresholds of multiple traffic types of a link type. In actual implementation, the user layer apparatus includes a first unit and a second unit. The first unit is adapted to set link parameter thresholds corresponding to different traffic types of a link type, and the second unit is adapted to add the link parameter thresholds set by the first unit in a first threshold configuration request, and send the first threshold configuration request to other apparatuses such as an intermediate layer apparatus.

An intermediate layer apparatus is also provided in an embodiment of the present invention. The intermediate layer apparatus includes a first unit and a second unit. The first unit is adapted to obtain link parameter thresholds of all traffic types from a received first threshold configuration request, and the second unit is adapted to add the obtained link parameter thresholds in a second threshold configuration request, and send the second threshold configuration request to other apparatuses such as a link layer apparatus. Here, the first threshold configuration request is sent from a user layer apparatus.

As FIG. 6 shows, a link layer apparatus 53′ is also provided in an embodiment of the present invention. The link layer apparatus 53′ includes a first unit 531 and a second unit 532. The first unit 531 is adapted to obtain link parameter thresholds of different traffic types from a second threshold configuration request, and the second unit 532 is adapted to configure link parameter thresholds of the corresponding traffic types according to the link parameter thresholds, and generate a corresponding threshold configuration status.

It is known from the above embodiments that the method, apparatus, and system for configuring link parameter thresholds enable the user layer to configure the link parameter thresholds based on the traffic types so as to meet the requirements for communication quality of different traffics, and can configure the link parameter thresholds corresponding to one or more link types, so that the configuration efficiency is improved, and the configuration becomes more flexible.

Though illustration and description of the present disclosure have been given with reference to preferred embodiments thereof, it should be appreciated by persons of ordinary skill in the art that various changes in forms and details can be made without deviation from the spirit and scope of this disclosure, which are defined by the appended claims.

What is claimed is:

1. A method for configuring link parameter thresholds, comprising:
receiving, by an intermediate layer, link parameter thresholds corresponding to different traffic types of a link type, through a first threshold configuration request from an upper layer; and
sending, by the intermediate layer, the received link parameter thresholds through a second threshold configuration request to a link layer.

2. The method according to claim 1, wherein the link parameter thresholds are set and recorded in the first threshold configuration request by the upper layer.

3. The method according to claim 1, the sending step further comprising:
recording, by the intermediate layer, the link parameter thresholds in the second threshold configuration request generated for the link type, and sending the second threshold configuration request to the link layer.

4. The method according to claim 1, wherein the first threshold configuration request further comprises a destination identifier.

5. The method according to claim 1, further comprising:
obtaining, by the link layer, the link parameter thresholds corresponding to different traffic types from the second threshold configuration request, and configuring link parameter thresholds of the corresponding traffic types according to the link parameter thresholds.

6. The method according to claim 5, after the configuring step, further comprising:
generating, by the link layer, a threshold configuration status of the link type, and sending a first threshold configuration confirmation carrying the threshold configuration status to the intermediate layer; and
obtaining, by the intermediate layer, the threshold configuration status from the first threshold configuration confirmation sent from the link layer, adding the threshold configuration status into a second threshold configuration confirmation of the link type, and sending the second threshold configuration confirmation to the upper layer.

7. The method according to claim 5, further comprising:
initiating, by the link layer, a link parameter change report of the corresponding link when actual link parameters exceed the link parameter thresholds.

8. The method according to claim 6, wherein the first threshold configuration confirmation further comprises a source identifier.

9. The method according to any one of claims 1, wherein the configuration method is applied in a procedure of media independent handover, MIH, the upper layer is an MIH user layer, the intermediate layer is an MIH layer, the first threshold configuration request is an MIH configure thresholds request message, and the second threshold configuration request is a link configure thresholds request message.

10. An apparatus for configuring link parameter thresholds, comprising:
an upper layer entity, adapted to send link parameter thresholds corresponding to different traffic types of a link type through a first threshold configuration request.

11. The apparatus according to claim 10, wherein the apparatus further comprises:
an intermediate layer entity, adapted to obtain the link parameter thresholds corresponding to different traffic types from the first threshold configuration request, and send the obtained link parameter thresholds corresponding to different traffic types to a link layer entity through a second threshold configuration request.

12. The apparatus according to claim 10, wherein the upper layer entity comprises:
a first unit, adapted to set the link parameter thresholds corresponding to different traffic types of a link type; and
a second unit, adapted to record the link parameter thresholds corresponding to different traffic types in the first threshold configuration request, and send the first threshold configuration request to the intermediate layer entity.

13. The apparatus according to claim 11, wherein
the intermediate layer entity is further adapted to record the link parameter thresholds of different traffic types in the second threshold configuration request generated for the link type upon receiving the first threshold configuration request, and send the second threshold configuration request to the link layer entity.

14. The apparatus according to claim 11, wherein the apparatus further comprises:
an link layer entity, adapted to obtain the link parameter thresholds of different traffic types from the second threshold configuration request, and configure link parameter thresholds of the corresponding traffic types according to the link parameter thresholds.

15. The apparatus according to claim 14, wherein
the link layer entity is further adapted to generate a threshold configuration status for the link type, and send a first threshold configuration confirmation carrying the threshold configuration status to the intermediate layer entity; and
the intermediate layer entity is further adapted to obtain the threshold configuration status from the first threshold configuration confirmation sent from the link layer, add the threshold configuration status into a second threshold configuration confirmation of the link type, and send the second threshold configuration confirmation to the upper layer entity.

16. An apparatus for configuring link parameter thresholds, comprising:
a link layer entity, adapted to obtain link parameter thresholds of different traffic types, and configure link parameter thresholds of the corresponding traffic types according to the link parameter thresholds.

17. The apparatus according to claim 16, wherein the link layer entity comprises:
a first unit, adapted to receive a second threshold configuration request, and obtain the link parameter thresholds corresponding to different traffic types from the second threshold configuration request; and
a second unit, adapted to configure link parameter thresholds of the corresponding traffic types according to the link parameter thresholds, and generate a corresponding threshold configuration status.

18. The apparatus according to claim 16, wherein the apparatus further comprises:
an intermediate layer entity, adapted to obtain link parameter thresholds corresponding to different traffic types from a first threshold configuration request, and send the obtained link parameter thresholds corresponding to different traffic types to the link layer entity through the second threshold configuration request generated for the link type.

19. The apparatus according to claim 18, wherein
the link layer entity is further adapted to generate a threshold configuration status for the link type, and send a first threshold configuration confirmation carrying the threshold configuration status to the intermediate layer entity; and
the intermediate layer entity is further adapted to obtain the threshold configuration status from the first threshold configuration confirmation sent from the link layer, add the threshold configuration status into a second threshold configuration confirmation of the link type, and send the second threshold configuration confirmation to an upper layer entity.

20. The apparatus according to claim 16, wherein
the link layer entity is further adapted to initiate a link parameter change report of the corresponding link when actual link parameters exceed the link parameter thresholds.
